(19) United States
(12) Patent Application Publication
(10) Pub. No.: US 2016/0194120 A1
(43) Pub. Date: Jul. 7, 2016

(54) CONTAINERS PREVENTING FORGERY OR ADULTERATION

(71) Applicant: José Antonio PÉREZ GUEVARA, Estado de México (MX)

(72) Inventor: José Antonio PÉREZ GUEVARA, Estado (MX)

(21) Appl. No.: 14/912,921

(22) PCT Filed: Apr. 28, 2014
(86) PCT No.: PCT/MX2014/000065

§ 371 Date: Feb. 19, 2016

(30) Foreign Application Priority Data
Sep. 24, 2013 (MX) MX/U/2013/000476

(51) Int. Cl. B65D 49/00; A61J 1/14; A45D 34/00

(52) U.S. Cl. CPC B65D 49/00; A45D 34/00; A61J 1/14

(57) ABSTRACT

The invention relates to the modification applied to different types of containers made from glass or other materials in order to render them unusable as original containers. The invention consists in the modification of the design, structure and production of any container forming same in two parts connected by a tubular element surrounded by a plastic or other material which provides rigidity, but which also facilitates the disablement thereof by means of the application of a force by the consumer, facilitating the breakage thereof and preventing the subsequent use thereof as original container. In terms of the historical development of containers, this application is novel in that it can be used to eliminate the forgery of containers or bottles used in international and national perfumery, wine, pharmaceutical and other industries, providing an instrument which is more than effective in controlling forgery and adulteration in the above-mentioned markets.

### INVENTION FIELD

The invention herein generally refers to a system used to disable the use of containers, especially, to a mechanism to enable the controlled breaking of containers for commercial products, by applying torsional stress from the user,

### INVENTION BACKGROUND

Currently, the struggle against forgery or piracy of commercial products and, especially, products in glass bottles, or bottles made of other materials, used in the perfume, wine and pharmaceutical industry, for example, has become one of the biggest concerns for legitimate businessmen, who try to protect the integrity of their products and make sure the consumers always know they are purchasing an original and legitimate product. Thus, several safety devices have been developed to validate the original quality of the container and its content. Nevertheless, there is not a system that focuses on disabling the use of the container to prevent it from being reused.

In view of the above, it is necessary to provide a system that allows the disabling of containers for commercial products, in order to prevent them from being reused, which avoid piracy of products from industries such as the perfume, wine and pharmaceutical industry, preventing forgery of their contents and making the user feel more confident about the authenticity of the contents,

### INVENTION SUMMARY

In order to solve the problems above, the invention herein is aimed at providing a system to prevent the containers from being reused.

One of the main objectives of this invention is to provide a system to disable containers that can be performed in an economic way through some modifications to the manufacturing process of such container.

Another objective of this invention is to provide a mechanism for the controlled rupture of a container by applying external strength from a user.

Another objective of this invention is to provide a system to disable containers, which can be applied to any type of container, regardless of its shape or manufacturing materials.

Another objective of the invention herein is to provide a system to disable containers which, once they have been used, can be recycled through conventional methods.

Another objective of this invention is to provide a container comprising the disabling system described in the invention herein.

The aforementioned objectives, as well as other objectives, and the advantages of the invention herein will become evident through the following detailed description thereof.

### DESCRIPTION OF THE FIGURES ILLUSTRATING THE INVENTION

FIG. 1 is the representation of this invention's system location in various kinds and shapes of containers.

FIG. 2 is a view of a container with the system in the invention herein.

FIG. 3 is a view of the container-disabling system, showing the location of the breaking mechanism in the invention herein.

FIG. 4 is a lateral view of a container with the system in the invention herein, showing the location of each one of the elements.

FIG. 5 shows a cut of a container with the system in the invention herein.

FIG. 6 shows the operation of the system when applying torsion strength.

FIG. 7 shows a container after breaking the rupture mechanism in the invention herein.

### DETAILED DESCRIPTION OF THE INVENTION

The invention relates to the modification applied to different types of containers made from glass or other materials in order to render them unusable as original containers.

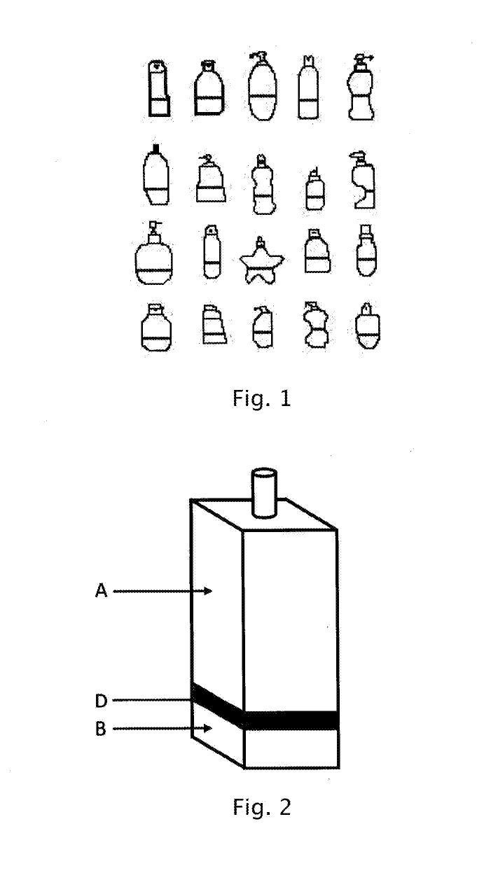

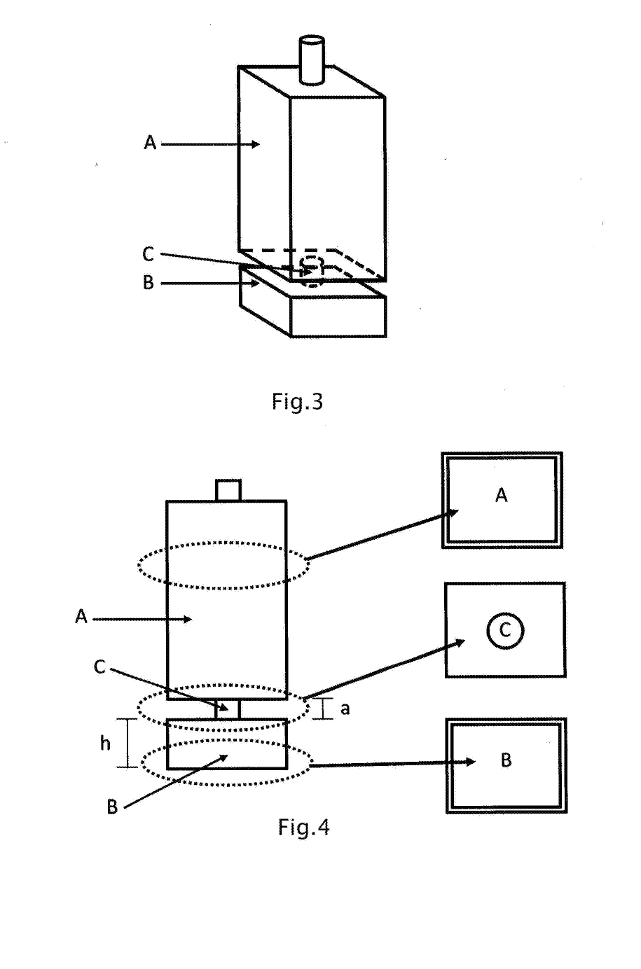

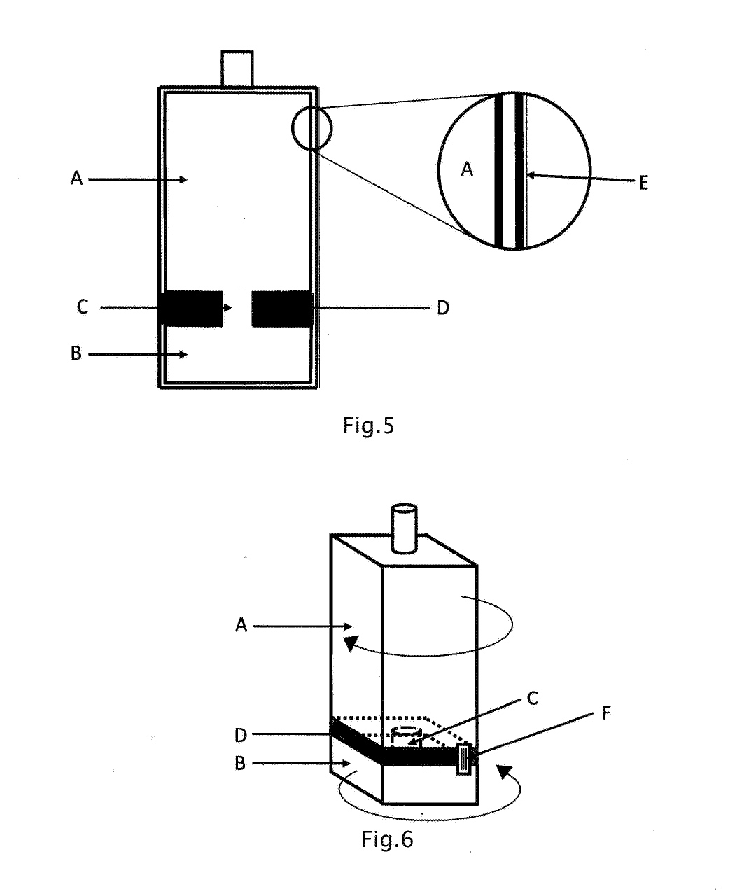

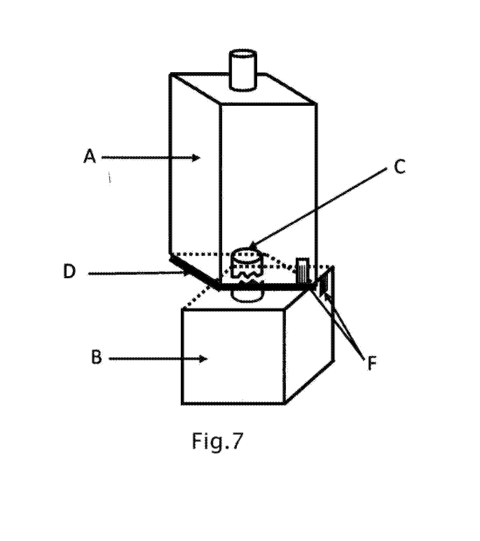

As seen in FIGS. 1 to 7, the invention refers to a system comprising a breaking mechanism, which consists of a constriction in the body of a container, modifying the manufacturing or blowing molds, or any kind of mold, in such a way that a tube (c) is formed as a breaking point in the body of the container; such tube (c) can have any desired configuration (circular, semi-circular or any other) and it divides the container into two sections (A) and (B) located at the top and the bottom of the container, respectively. The height (h) of the section (B) is previously determined to generate a maximum-grip area. As seen in FIGS. (2) to (4), the tube (c) is built into sections (A) and (B), and it creates a variable height space (a) where a ring (D) is located, which is made from plastic or other appropriate material, with smooth surfaces, which makes contact with the sections (A) and (B) of the container, strengthening the tube (C) in order to mechanically support the container and allow the safe transfer and use of the container, under normal conditions. Once the ring is formed, at least one safety element (F) is placed, which can be a label, a hologram, a seal or any other kind of element (FIG. 6); joining the external surfaces of the sections (A) and (B), which is placed on the external part of the ring (D).

Once the system is formed, it can be covered by a different clear material, covering the sections (A) and (B) and the ring, and creating a continuous external surface, as seen in FIG. (5), in such a way that, when torsion strength is applied by the user between those sections (A) and (B) and breaking the tube (C) dividing sections (A) and (B) into two separate parts, these are trapped, inside the film (E), as well as the tube fragment (C), the ring (D) and at least one safety element (F), which will be broken, rendering the container unusable.

The system described above allows an external torsion strength applied by the user on sections (A) and (B) to break the tube (C) by rotating the sections (A) and (B) in opposite directions, compromising the integrity of the container's body and the safety element (F), as shown in FIGS. (6) and (7). Such rupture prevents the container from being reused as leak areas will be created, and the tube (C) material fragments are contained in the ring (D) and the film (E), preventing them from falling out.

1. A system to disable the body of a container characterized by comprising:
a) a rupture mechanism used to make the container more fragile, with a constriction or tube (C) used to divide the container into two sections (A) and (B), separated by a space (a), in such away that such sections are comprehensively joined by the tube (C);
b) a strengthening material used to create a ring (D) restricting the movement between sections (A) and (B), also providing mechanical support to the container during its use and transportation and;
c) at least one safety element (F) placed sections (A) and (B) and on the external surface of the ring (D), in such a way that when a user applies torsion strength between such sections (A) and (B), the tube (C) turns into a breaking point, compromising the integrity of the tube, dividing sections (A) and (B) into two parts, and breaking at least one safety element (F) rendering the container unusable.

2. The system, according to claim 1, is characterized by a film (E) made from a clear material covering sections (A) and (B) and the ring (D) between sections (A) and (B) to create a continuous external surface, in such a way that when the user applies torsion strength between such sections (A) and (B) and the tube (C) breaks, dividing sections (A) and (B) into two sections, which are trapped inside the film (E), along with the tube fragments (C), the ring (D) and breaking at least one safety element (F), rendering the container unusable.

3. The system, according to claim 1, is characterized by the tube (c) having a circular, triangular, semi-circular shape, or any other shape required.

4. The system, according to claim 1 is characterized by having a strengthening material, either plastic or a different material to provide the mechanical support the container requires.

5. The system, according to claim 1, is characterized by having at least one safety element, either a seal, a hologram, a label, a barcode or a numeric code.

6. The system, according to any claim from 1 to 5, is characterized by having a container for commercial products, made from a material selected from a consistent group, either glass or other appropriate materials,

7. The system, according to claim 6, is characterized by being placed in a container for alcoholic beverages.

8. The system, according to claim 6, is characterized by being placed in a container for perfume.

9. The system, according to claim 6, is characterized by being placed in a container for pharmaceutical products.

10. Container for products, characterized, by comprising the disabling system from claims 1-9.
